(19) United States
(12) Patent Application Publication
(10) Pub. No.: US 2018/0096359 A1
(43) Pub. Date: Apr. 5, 2018

(54) NETWORK TRANSACTION SYSTEM AND TRANSACTION PLATFORM SERVER FOR NETWORK TRANSACTION PLATFORM

(71) Applicants: ZHEJIANG GEELY HOLDING GROUP CO., LTD, Hangzhou (CN); ZHEJIANG GEELY AUTOMOBILE RESEARCH INSTITUTE CO., LTD., Taizhou (CN)

(72) Inventor: Shufu LI, Hangzhou (CN)

(21) Appl. No.: 15/563,853

(22) PCT Filed: Mar. 30, 2016
(86) PCT No.: PCT/CN2016/077861

§ 371 Date: Oct. 2, 2017

(30) Foreign Application Priority Data
Apr. 2, 2015 (CN) 201510154555.6

(51) Int. Cl. G06Q 30/00; G06Q 20/12; G06Q 30/06; G06Q 20/08; G06Q 20/02

(52) U.S. Cl. CPC G06Q 30/016; G06Q 20/12; G06Q 20/027; G06Q 30/0613; G06Q 20/0855; G06Q 30/0609

(57) ABSTRACT

The present invention provides a network transaction system for a network transaction platform, comprising a transaction platform sub-system, a service fee sub-system, an incentive fund sub-system and a seller client. The transaction platform sub-system calculates service fee data for transactional capital of each transaction according to a pre-determined service fee ratio, and sends the service fee to the service fee sub-system. The incentive fund sub-system calculates, according to all service fee data in a pre-determined period, a seller payment ratio of the sum of service fee corresponding to all transactions of each seller in the pre-determined period to a total service fee in the pre-determined period, and sends corresponding incentive fund to a corresponding seller based on the seller payment ratio according to the total incentive fund. The network transaction system further realizes an electronic agreement being signed between the transaction platform sub-system and the seller client. The present invention is capable of further improving security in transactions and reducing an instantaneous load in data processing for the server and the total data processing amount.

### FIELD OF THE INVENTION

The present invention relates to the field of e-commerce, and especially to a network transaction system and transaction platform server for a network transaction platform.

### BACKGROUND OF THE INVENTION

There are a variety of network transaction platforms at present, such as Taobao, Amazon, ebay, etc., and more and more consumers are keen on shopping through the Internet. Compared to solid shops, stores on network transaction platforms typically can provide more competitive commodity prices and more convenient shopping experiences. However, shopping on network transaction platforms obviously would be faced up to shopping risks such as fake merchandise or frauds, etc.

With regard to some network transaction platforms, the sale subjects thereof are various stores therein, and the network transaction platforms only provide a uniform sales platform for the various stores and manage the normal operation of the platform. As such, when having a transaction dispute with a store on the platform, in practice, a consumer, or in other words, a buyer usually can only initiate a rights protection action directly to the store. As is well known, most stores in the network transaction platforms are small-scale stores, and have the features of living for a short time, having small compensation ability and the like. Therefore, generally, it is difficult for a consumer to protect rights with respect to a store. Although the creator of a network transaction platform is generally a large-scale enterprise with abundant financial resources and is stable, since the transaction platform is not a seller in a transaction, a consumer usually cannot initiate a rights protection action directly with respect to the network transaction platform.

### SUMMARY OF THE INVENTION

The inventor of the present application proposes a technical solution that will be described in the following, based on a network transaction system newly designed thereby. In the new network transaction system, a transaction platform sub-system providing a network transaction platform extracts, for stores on the transaction platform sub-system, a service fee in a certain ratio according to each transaction and sends same to a service fee sub-system, and the service fee is collected and counted by the service fee sub-system. In this way, when a consumer has a transaction dispute with a store on the platform, the consumer can propose a rights protection and claim request to the service fee sub-system. The service fee sub-system pays compensation to the consumer according to an infringement fact, which can significantly reduce the shopping risks for the consumer, and improve the security of network transactions. In such a platform operation mode, a critical foundation is signing an agreement between the network transaction system and a store. For the signing of the agreement, there are still technical problems such as improving the data processing efficiency in agreement signing and the convenience in an electronic transaction procedure and an electronic application examination procedure that need to be solved. For this purpose, the following technical solutions are proposed in the present application.

According to one aspect of the present invention, provided is a network transaction system or network transaction method for a network transaction platform, comprising a transaction platform sub-system, a service fee sub-system, an incentive fund sub-system and a seller client. In one embodiment, a transaction platform sub-system, a service fee sub-system, an incentive fund sub-system and a seller client can be mutually independent or relatively independent.

The transaction platform sub-system is configured to provide a network transaction platform between a buyer and a seller and manage the transaction procedure and transactional capital of each transaction between the buyer and the seller; and the transaction platform sub-system is further configured to calculate service fee data for transactional capital of each transaction according to a pre-determined service fee ratio, and sends each of the service fee data to the service fee sub-system and the incentive fund sub-system, and sends service fee corresponding to each of the service fee data to the service fee sub-system;

the service fee sub-system is configured to receive each of the service fee data and the corresponding service fee from the transaction platform sub-system; and

the incentive fund sub-system is configured to receive each of the service fee data from the transaction platform sub-system, and calculate, according to all service fee data in a pre-determined period, a seller payment ratio of the sum of service fee corresponding to all transactions of each seller in the pre-determined period to a total service fee in the pre-determined period; and the incentive fund sub-system is further configured to send corresponding incentive fund to a corresponding seller based on the seller payment ratio of each seller according to the total incentive fund in the pre-determined period.

Optionally, the transaction platform sub-system is further configured to calculate net transactional capital data after each of the transactional capital is subtracted by the corresponding service fee, and send the net transactional capital data and the service fee data to the seller client, and the transaction platform sub-system is further configured to send net transactional capital corresponding to the net transactional capital data to the seller.

Optionally, the transaction platform sub-system is further configured to receive a right defending request from the buyer and forward the right defending request to the service fee sub-system, and the service fee sub-system is further configured to send compensation fund to the buyer in the case where the right defending request of the buyer is established.

Optionally, the transaction platform sub-system, the service fee sub-system and the incentive fund sub-system are mutually independent systems.

Optionally, the transaction platform sub-system and the seller client are further configured to interact via a network, so as to sign an electronic agreement between the transaction platform sub-system and the seller, wherein the electronic agreement comprises a convention related to the service fee and the incentive fund.

Optionally, the signing of the electronic agreement is started by the transaction platform sub-system or the seller client, wherein the transaction platform sub-system is further configured to send the electronic agreement to be signed to the seller client, and the seller client is further configured to send to the transaction platform sub-system a confirmation result indicating whether the seller accepts the electronic agreement; and wherein the transaction platform sub-system sends the service fee to the service fee sub-system for each transaction of the seller only in the case of having received a confirmation result from the seller client indicating that the seller accepts the electronic agreement.

Optionally, the seller client is further configured to generate a store setting up request according to an input of the seller, and send the store setting up request to the transaction platform sub-system, so as to start the signing of the electronic agreement.

Optionally, the transaction platform sub-system is further configured to detect whether the electronic agreement has been signed between the transaction platform sub-system and the store; and in the case where the electronic agreement has not been signed, the transaction platform sub-system generates an agreement signing instruction, so as to start signing the electronic agreement for the store.

Optionally, the transaction platform sub-system is further configured to monitor an order initiated by a buyer on the transaction platform sub-system, and detect whether the electronic agreement has been signed between the transaction platform sub-system and the store corresponding to the order in response to the monitored order; and in the case where the electronic agreement has not been signed, the transaction platform sub-system suspends the procedure of the order and generates an agreement signing instruction, so as to start signing the electronic agreement for the store corresponding to the order.

Optionally, the transaction platform sub-system is further configured to store agreement signing state information corresponding to the store in the transaction platform sub-system, for indicating whether the transaction platform sub-system has signed the electronic agreement with the store; and the agreement signing state information selectively has a signed state and an unsigned state; and the transaction platform sub-system determines whether the electronic agreement has been signed according to the agreement signing state information about the store.

Optionally, the transaction platform sub-system is further configured to set the agreement signing state information about the store to the signed state after receiving the confirmation result from the seller client indicating accepting the electronic agreement.

Optionally, the transaction platform sub-system is further configured to generate, in a page of the store presented to the buyer, an agreement signing state flag visible to the buyer corresponding to the agreement signing state information, for presenting to the buyer whether the store has signed the electronic agreement with the transaction platform sub-system.

Optionally, the transaction platform sub-system is further configured to acquire store information about the store.

Optionally, the seller client is further configured such that the seller fills, by means of the seller client, the store information in an information collection form for collecting the store information, and to send the information collection form having filled with the store information to the transaction platform sub-system; and the transaction platform sub-system is further configured to extract the store information in the information collection form, and store the store information in the transaction platform sub-system.

Optionally, the transaction platform sub-system is further configured to send the information collection form to be filled in and a form filling in request to the seller client in response to the agreement signing instruction of the transaction platform sub-system or the store setting up request from the seller client; and the seller client is further configured to present the information collection form to the seller for the seller to fill in, in response to the form filling in request.

Optionally, the seller client is further configured to pre-set in the seller client the information collection form which has not been filled in.

Optionally, the seller client is further configured to send the information collection form in which the store information has been filled together with the store setting up request to the transaction platform sub-system.

Optionally, the seller client is further configured to receive a form filling in request from the transaction platform sub-system, and present the information collection form to the seller for the seller to fill in, in response to the form filling in request.

Optionally, the transaction platform sub-system is further configured to examine store information about a store of the seller.

Optionally, examining the store information by the transaction platform sub-system comprises: detecting whether the store information is complete for signing the electronic agreement.

Optionally, the transaction platform sub-system is further configured to send the form filling in request to the seller client in the case where the store information is not complete.

Optionally, examining the store information by the transaction platform sub-system comprises: according to the store information, determining whether the store satisfies an agreement signing requirement for signing the electronic agreement pre-determined by the transaction platform sub-system or whether the store has reached an elimination standard pre-determined by the transaction platform sub-system; and the transaction platform sub-system is further configured to terminate signing the electronic agreement when the store does not satisfy the agreement signing requirement and to revoke the store from the transaction platform sub-system when the store reaches the elimination standard.

Optionally, one or more items in the store information are risk relevant items related to store operation risks; the transaction platform sub-system is further configured to calculate a risk factor of the store by utilizing the risk relevant items according to a pre-determined algorithm, compare the risk factor to a pre-determined risk threshold, and generate a comparison result; and the transaction platform sub-system determines according to the comparison result whether the store satisfies the agreement signing requirement or reaches the elimination standard.

Optionally, a pre-set risk coefficient and weight corresponding to various risk relevant items are stored in the transaction platform sub-system, and the risk factor is obtained by calculating according to the risk coefficient and weight of the risk relevant items in the store information.

Optionally, at least one of the risk relevant items is processing result data based on a right defending request for the store in the service fee sub-system.

Optionally, the service fee ratio is a pre-set fixed ratio, and optionally, the fixed ratio is 0-8%.

Optionally, the fixed ratio is 1%-5%, and further optionally, the fixed ratio is 3%.

Optionally, the service fee ratio is a ratio related to a store calculated according to store information, and one or more items in the store information are service fee relevant items related to the service fee ratio calculation, the transaction platform sub-system is further configured to calculate the service fee ratio by utilizing the service fee relevant items according to a pre-determined algorithm.

Optionally, the transaction platform sub-system is further configured to store in the transaction platform sub-system a pre-set service fee coefficient and weight corresponding to various service fee relevant items, and the service fee ratio is obtained by calculating according to the service fee coefficient and weight of the service fee relevant items in the store information.

Optionally, the service fee ratio is inversely proportional to an accumulated transaction volume of the store, thus the service fee ratio gradually decreases as the transaction volume of the store increases; and the starting point of the service fee ratio is 8%.

Optionally, the transaction platform sub-system is further configured to load the service fee ratio on a pre-set agreement template, so as to generate the electronic agreement.

Optionally, the transaction platform sub-system is further configured to terminate signing the electronic agreement in the case of receiving a confirmation result from the seller client indicating that the seller refuses to accept the electronic agreement.

Optionally, the transaction platform sub-system is further configured such that: in the case where the signing of the electronic agreement is started by the seller client, when terminating signing the electronic agreement, the transaction platform sub-system generates and sends a piece of request refusal information to the seller client, so as to indicate to the seller that the currently conducted signing of the electronic agreement is terminated; and/or in the case where the signing of the electronic agreement is started by the transaction platform sub-system, when terminating signing the electronic agreement, the transaction platform sub-system generates and sends transaction failure information to the seller client, so as to indicate to the seller that the order is terminated due to that the electronic agreement cannot be signed.

According to another aspect of the present invention, provided is a transaction platform server for a network transaction system, for interacting with a service fee server, an incentive fund server and a seller client through a network, so as to manage the transaction procedure and transactional capital of each transaction on a network transaction platform between a buyer and a seller and complete a capital flow between electronic accounts of the buyer and the seller, the transaction platform server comprising:

a store examination module configured to examine store information about the seller's store;

a service fee determination module configured to determine according to a pre-determined policy a service fee ratio that the transaction platform server would charge the store;

an agreement generation and sending module configured to load the service fee ratio on a pre-set agreement template to generate an electronic agreement to be signed, and send the electronic agreement to the seller client, wherein the electronic agreement comprises a convention related to the service fee;

a confirmation result receiving module configured to receive a confirmation result from the seller client indicating whether the seller accepts the electronic agreement; and

a payment module configured to pay the service fee corresponding to the service fee data to an electronic account corresponding to the service fee server, and pay net transactional capital to an electronic account corresponding to the seller client after deducting the service fee from the transaction capital;

wherein the transaction platform server starts the signing of the electronic agreement in response to an agreement signing instruction in the transaction platform server or a store setting up request from the seller client.

Optionally, the transaction platform server further comprises:

an agreement detection module configured to detect whether the electronic agreement has been signed between the network transaction platform and the store; and

an instruction generation module configured to generate the agreement signing instruction in the case where the electronic agreement is not signed.

Optionally, the transaction platform server further comprises:

an order monitoring module configured to monitor an order initiated by a buyer on the network transaction platform;

a store determination module configured to determine a store corresponding to the order; and

an order processing module for managing an order procedure and configured to suspend the procedure of the order in the case where the store has not signed the electronic agreement;

wherein the agreement detection module detects whether the electronic agreement has been signed for the store determined by the store determination module.

Optionally, the store information comprises the agreement signing state information, for indicating whether the network transaction platform has signed the electronic agreement with the store; the agreement signing state information selectively has a signed state and an unsigned state; and the agreement check module is configured to determine whether the electronic agreement has been signed according to the agreement signing state information about the store.

Optionally, the transaction platform server further comprises: a signing state setting module configured to set the agreement signing state information about the store to the signed state after the confirmation result receiving module receives the confirmation result from the seller client indicating accepting the electronic agreement.

Optionally, the transaction platform server further comprises: an agreement signing state flag generation module configured to generate, in a page of the store presented to the buyer by the network transaction platform, an agreement signing state flag visible to the buyer corresponding to the agreement signing state information, for presenting to the buyer whether the store has signed the electronic agreement with the network transaction platform.

Optionally, the transaction platform server further comprises: a store information acquisition module configured to acquire the store information about the store.

Optionally, the store information acquisition module comprises:

a form receiving unit configured to receive an information collection form from the seller client in which the store information has been filled; and

an information extraction unit configured to extract the store information from the information collection form, and store the store information in a store information memory.

Optionally, the store information acquisition module further comprises: a form transmission unit configured to send the information collection form to be filled in and a form filling in request to the seller client in response to the agreement signing instruction or the store setting up request from the seller client, wherein the seller client presents the information collection form to the seller for the seller to fill in, in response to the form filling in request.

Optionally, the store examination module comprises: an information completeness detection unit configured to detect whether the store information is complete for signing the electronic agreement.

Optionally, the information completeness detection unit is further configured to send an information acquisition request to the store information acquisition module in the case where the store information is incomplete; and the store information acquisition module is further configured to send the form filling in request to the seller client in response to the information acquisition request.

Optionally, the store information examination module comprises:

an agreement signing requirement examination unit configured to determine according to the store information whether the store satisfies a pre-determined requirement for signing the electronic agreement.

Optionally, the transaction platform server further comprises: an agreement signing termination module configured to: when the store does not satisfy the agreement signing requirement or when the seller refuses to accept the electronic agreement, and in the case where the signing of the electronic agreement is started by the seller client, generate and send a piece of request refusal information to the seller client, so as to indicate to the seller that the currently conducted signing of the electronic agreement is terminated; or, when the store does not satisfy the agreement signing requirement or when the seller refuses to accept the electronic agreement, and in the case where the signing of the electronic agreement is started by the network transaction platform, generate and send transaction failure information to the seller client, so as to indicate to the seller that the order is terminated due to that the electronic agreement cannot be signed.

Optionally, one or more items in the store information are risk relevant items related to store operation risks; wherein the agreement signing requirement examination unit is further configured to calculate a risk factor of the store by utilizing the risk relevant items according to a pre-determined algorithm, compare the risk factor to a pre-determined risk threshold, and determine whether the store satisfies the agreement signing requirement according to a comparison result.

Optionally, a pre-set risk coefficient and weight corresponding to various risk relevant items are stored in the transaction platform server, and the risk factor is obtained by calculating according to the risk coefficient and weight of the risk relevant items in the store information.

Optionally, the service fee ratio is a pre-set fixed ratio, and optionally, the fixed ratio is 0-8%.

Optionally, the fixed ratio is 1%-5%, and further optionally, the fixed ratio is 3%.

Optionally, the service fee ratio is a ratio related to a store calculated according to store information, and one or more items in the store information are service fee relevant items related to the service fee ratio calculation; wherein the service fee determination module is further configured to calculate the service fee ratio by utilizing the service relevant items according to a pre-determined algorithm.

Optionally, a pre-set service fee coefficient and weight corresponding to various service fee relevant items are stored in the transaction platform server, and the service fee ratio is obtained by calculating according to the service fee coefficient and weight of the service fee relevant items in the store information.

Optionally, the agreement generation and sending module is further configured to load the service fee ratio on a pre-set agreement template, so as to generate the electronic agreement.

Optionally, the transaction platform server further comprises: a right defending request receiving and forwarding module configured to receive a right defending request from the buyer and forward the right defending request to the service fee server.

According to another aspect of the present invention, provided is a network transaction system, comprising a service fee server, an incentive fund server, a seller client and a transaction platform server as previously described; wherein,

the service fee server is configured to receive each of the service fee data and the corresponding service fee from the transaction platform server, and pay compensation fund to a buyer in the case where the buyer's right defending request is established; and

the incentive fund server is configured to receive each of the service fee data from the transaction platform server, and calculate, according to all service fee data in a pre-determined period, a seller payment ratio of the sum of service fee corresponding to all transactions of each seller in the pre-determined period to a total service fee in the pre-determined period; and the incentive fund server is further configured to send corresponding incentive fund to a corresponding seller based on the seller payment ratio of each seller according to the total incentive fund in the pre-determined period.

According to one aspect of the present invention, provided is a network agreement signing method, for interaction between a network transaction platform or transaction platform server and a seller client at a seller side via a network, so as to sign an electronic agreement between the network transaction platform and a seller of a store on the network transaction platform. The method can comprise:

the network transaction platform or the seller client starting the signing of the electronic agreement;

the network transaction platform examining store information about the seller's store;

the network transaction platform sending the electronic agreement to be signed to the seller client; and

the seller client sending to the network transaction platform a confirmation result indicating whether the seller accepts the electronic agreement.

Optionally, the method can further comprise: the seller client generating a store setting up request according to an input of the seller, and sending the store setting up request to the network transaction platform, so as to start the signing of the electronic agreement.

Optionally, the method can further comprise: the network transaction platform detecting whether the electronic agreement has been signed between the network transaction platform and the store; and in the case where the electronic agreement has not been signed, the network transaction platform generating an agreement signing instruction, so as to start signing the electronic agreement for the store.

Optionally, the method can further comprise:

the network transaction platform monitoring an order initiated by a buyer on the network transaction platform;

in response to the monitored order, the network transaction platform detecting whether the electronic agreement has been signed between the network transaction platform and a store corresponding to the order; and

in the case where the electronic agreement has not been signed, the network transaction platform suspending the procedure of the order and generating an agreement signing instruction, so as to start signing the electronic agreement for the store corresponding to the order.

Optionally, agreement signing state information corresponding to the store is stored in the network transaction platform, for indicating whether the network transaction platform has signed the electronic agreement with the store; the agreement signing state information selectively has a signed state and an unsigned state; and the network transaction platform determines whether the electronic agreement has been signed according to the agreement signing state information about the store.

Optionally, the method can further comprise: the network transaction platform setting the agreement signing state information about the store to the signed state after receiving the confirmation result from the seller client indicating accepting the electronic agreement.

Optionally, the method can further comprise: generating, in a page of the store presented to the buyer by the network transaction platform, an agreement signing state flag visible to the buyer corresponding to the agreement signing state information, for presenting to the buyer whether the store has signed the electronic agreement with the network transaction platform.

Optionally, the method can further comprise: the network transaction platform acquiring the store information about the store.

Optionally, acquiring the store information can comprise: the seller filling, by means of the seller client, the store information in an information collection form for collecting the store information; the seller client sending the information collection form having filled with the store information to the network transaction platform; and the network transaction platform extracting the store information in the information collection form, and storing the store information in the network transaction platform.

Optionally, the method can further comprise: the network transaction platform sending the information collection form to be filled in and a form filling in request to the seller client in response to the agreement signing instruction of the network transaction platform or the store setting up request from the seller client, wherein the seller client presents the information collection form to the seller for the seller to fill in, in response to the form filling in request.

Optionally, the information collection form which has not been filled in is pre-set in the seller client.

Optionally, the seller client sends the information collection form in which the store information has been filled together with the store setting up request to the network transaction platform.

Optionally, the method can further comprise:

the seller client receiving the form filling in request from the network transaction platform; and

the seller client presenting the information collection form to the seller for the seller to fill in, in response to the form filling in request.

Optionally, examining the store information can comprise: the network transaction platform detecting whether the store information is complete for signing the electronic agreement.

Optionally, the method can further comprise: the network transaction platform sending the form filling in request to the seller client in the case where the store information is not complete.

Optionally, examining the store information can comprise: the network transaction platform determining, according to the store information, whether the store satisfies an agreement signing requirement for signing the electronic agreement pre-determined by the network transaction platform; and when the store does not satisfy the agreement signing requirement, terminating signing the electronic agreement.

Optionally, one or more items in the store information are risk relevant items related to store operation risks; and the method can further comprise: the network transaction platform calculating a risk factor of the store by utilizing the risk relevant items according to a pre-determined algorithm; and comparing the risk factor to a pre-determined risk threshold, and generating a comparison result;

wherein the network transaction platform determines according to the comparison result whether the store satisfies the agreement signing requirement.

Optionally, a pre-set risk coefficient and weight corresponding to various risk relevant items are stored in the network transaction platform, and the risk factor is obtained by calculating according to the risk coefficient and weight of the risk relevant items in the store information.

Optionally, the network transaction platform terminates signing the electronic agreement in the case of receiving a confirmation result from the seller client indicating that the seller refuses to accept the electronic agreement.

Optionally, terminating signing the electronic agreement can comprise:

in the case where the signing of the electronic agreement is started by the seller client, the network transaction platform generating and sending a piece of request refusal information to the seller client, so as to indicate to the seller that the currently conducted signing of the electronic agreement is terminated.

Optionally, terminating signing the electronic agreement can comprise: in the case where the signing of the electronic agreement is started by the network transaction platform, the network transaction platform generating and sending transaction failure information to the seller client, so as to indicate to the seller that the order is terminated due to that the electronic agreement cannot be signed.

The service fee sub-system of the network transaction system according to the present invention can provide a right-defending channel and compensation to a buyer on a network transaction platform, assisting in improving the convenience and reliability of the buyer's right defending and the compensation. In an implementation, the service fee sub-system and the transaction platform sub-system providing the network transaction platform can be managed by the same operator. In another implementation, the service fee sub-system can be managed by a third-party independent operator different from the transaction platform sub-system, and this assists in improving the fairness in management of right defending caused by transaction disputes. The incentive fund sub-system of the network transaction system according to the present invention can increase the power for a seller on the network transaction platform to persist to honest business; in nature, the incentive fund sub-system can become a sub-system with the capability of guaranteeing the honesty of merchants on the transaction platform; once a merchant on the platform is found doing business dishonestly, the merchant's right to enjoy incentive fund is cancelled, otherwise the merchant would obtain certain incentive fund even more than the service fee paid thereby. In this way, the security in transactions and convenience in right defending and compensation are improved for a buyer on the network transaction platform. Further, the system and server according to the present invention can realize the automation of agreement signing to the greatest extent, and can conduct different processing procedures for a newly set up store and an already established store. Additionally, when a transaction platform server signs an agreement with a large amount of stores, according to the solution of the present invention, the time points of agreement signing can be distributed, preventing the transaction platform server from processing large amounts of work in a short time period, reducing the instantaneous load for the transaction platform server, and reducing the total data processing amount for the transaction platform server as far as possible.

According to the detailed description of the particular embodiments of the present invention below in conjunction with the accompanying drawings, the above-mentioned and other objects, advantages and features of the present invention will be more clear to a person skilled in the art.

### BRIEF DESCRIPTION OF THE DRAWINGS

Some of the particular embodiments of the present invention will be described below in detail in an exemplary but not limiting way with reference to the accompanying drawings. The same reference signs in the figures indicate the same or similar components or parts. A person skilled in the art should understand that these figures are not necessarily drawn to scale. In the accompanying drawings:

FIG. 1 is an overall structure of a network transaction system according to the present invention;

FIG. 2 is a flow chart of an embodiment of singing an electronic agreement between a transaction platform sub-system and a seller client of the network transaction system according to the present invention;

FIG. 3 is a more specific implementation flow chart of the network transaction system according to the present invention;

FIG. 4 is a structural schematic diagram of a transaction platform server for realizing the network transaction system of the present invention; and

FIG. 5 is an exemplary workflow of the network transaction system according to the present invention.

### DETAILED DESCRIPTION OF THE INVENTION

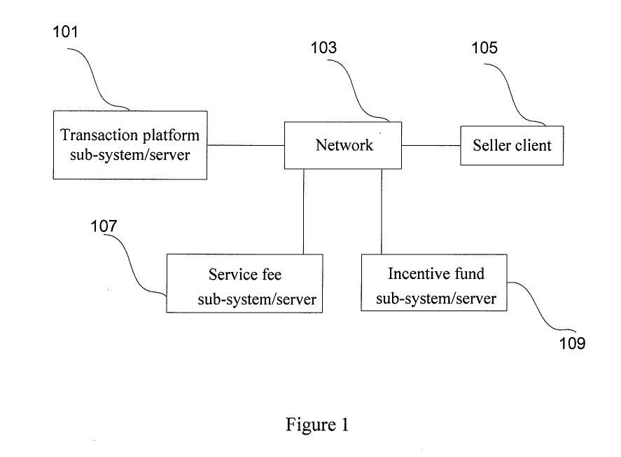

Referring to FIG. 1, the network transaction system of the present invention can comprise a transaction platform sub-system (or a transaction platform server) 101, a service fee sub-system (or a service fee server) 107, an incentive fund sub-system (or an incentive fund server) 109 and a seller client 105, which interact via a network 103, so as to exchange data. The data can comprise electronic forms, electronic agreements, electronic currency, pictures, audio and video, etc.

The transaction platform sub-system 101 can be configured to provide a network transaction platform between a buyer and a seller and manage the transaction procedure and transactional capital of each transaction between the buyer and the seller. The transaction platform server 101 can be further configured to calculate service fee data for transactional capital of each transaction according to a pre-determined service fee ratio, send each of the service fee data to the service fee sub-system and the incentive fund sub-system, and send service fee corresponding to each of the service fee data to the service fee sub-system 107. The service fee sub-system 107 can be configured to receive each of the service fee data and the corresponding service fee from the transaction platform sub-system. The incentive fund sub-system 109 can be configured to receive each of the service fee data from the transaction platform sub-system, and calculate, according to all service fee data in a pre-determined period, a seller payment ratio of the sum of service fee corresponding to all transactions of each seller or store in the pre-determined period to a total service fee in the pre-determined period. The incentive fund sub-system 109 can be further configured to send corresponding incentive fund to a corresponding seller based on the seller payment ratio of each seller according to the total incentive fund in the pre-determined period.

Further, the transaction platform sub-system 101 can be further configured to calculate net transactional capital data after each of the transactional capital is subtracted by the corresponding service fee (i.e. transactional capital with the service fee being deducted), and send the net transactional capital data and the service fee data to the seller client, and the transaction platform sub-system 101 can be further configured to send net transactional capital corresponding to the net transactional capital data to the seller.

Further, the transaction platform sub-system 101 can be further configured to receive a right defending request from the buyer and forward the right defending request to the service fee sub-system, and the service fee sub-system processes the right defending request. The service fee sub-system 107 can pay or send compensation fund to the buyer in the case where the right defending request of the buyer is established.

The transaction platform sub-system 101, the service fee sub-system 107 and the incentive fund sub-system 109 had better be mutually independent systems, so as to be and facilitating in being managed by different operators.

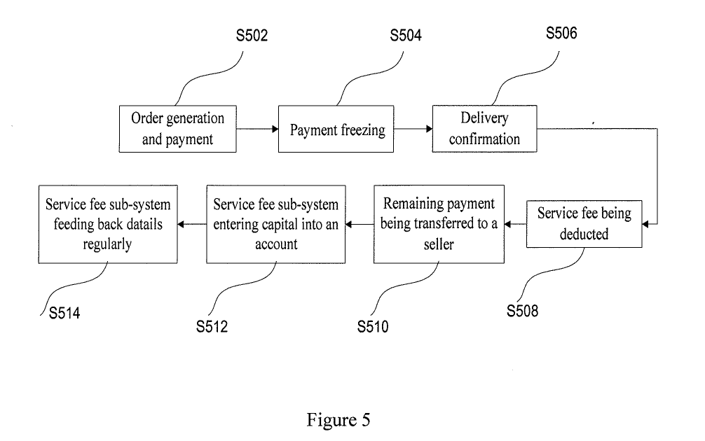

Referring to FIG. 5, in step S502, when a buyer selects a product in a store in a network transaction platform, a purchase and payment instruction are sent to the transaction platform sub-system 101, and payment (i.e. transaction capital) is transferred to the transaction platform sub-system via an electronic account. In step S504, the transaction platform sub-system 101 receives and freezes the transaction capital, and sends a payment success instruction to the buyer and a seller. The seller can arrange the delivery upon receiving the instruction, and the buyer can track the express delivery at any time after receiving the instruction and a transaction code, and wait for receiving the product. In step S506, after the buyer confirms the receipt, the transaction platform sub-system 101 unfreezes the transaction capital at random. In step S508, the transaction platform sub-system 101 extracts service fee from the transactional capital, and transfers to the service fee sub-system 107. In step S510, the transaction platform sub-system 101 transfers the remaining payment or the net transaction capital to the seller. In step S512, the service fee sub-system 107 receives the service fee from the transaction platform sub-system 101, and counts and records the service fee detail about each seller or store. In step S514, the service fee sub-system 107 feeds back the above-mentioned detail to a corresponding seller client regularly. When the buyer uses the product purchased on the network transaction platform and finds a quality problem with the product, the buyer can utilize a buyer client to complain and claim to the transaction platform sub-system 101, and the transaction platform sub-system 101 can send the complaint and claim to the service fee sub-system 107 for processing. Of course, the buyer can also utilize the buyer client to complain and claim directly to the service fee sub-system 107. The service fee sub-system 101 confirms the quality problem and pays corresponding compensation amount to the buyer. The incentive fund sub-system 109 regularly pays an incentive fee to the seller according to the ratio of the service fee paid by the seller to the collected total service fee on the service fee sub-system 107, and the total amount of the service fee can be related to the profit of the network transaction platform on the trading market and can also be related to the profit of the network transaction platform on the financial market. It can be understood that, in order to facilitate carrying out the payment in the above-mentioned steps, when the transaction platform sub-system 101 acquires store information about a store, the store information had better comprise registered capital information and receipt account information about the store, so that the network transaction platform, the service fee sub-system and the incentive fund sub-system receive and pay corresponding fees according to the receipt account information about the store.

Before the transaction platform sub-system 101 extracts the service fee from each transactional capital for the seller or store, the transaction platform sub-system 101 and the seller client 105 need to interact via a network 103, so as to sign a related electronic agreement between the transaction platform sub-system and the seller. The electronic agreement can comprise a convention related to the service fee and the incentive fund, for example, what are agreed on are the clauses of the network transaction system collecting the service fee from the store and the service fee ratio, the clauses of the system paying incentive fund to the store and calculation rules for the incentive fund, etc.

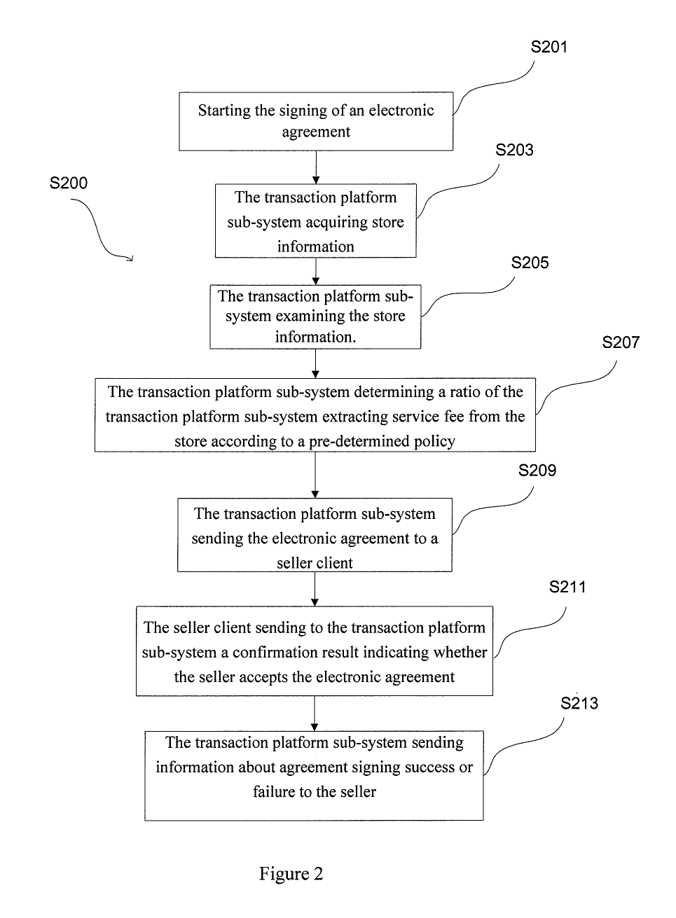

FIG. 2 shows a flow chart of the transaction platform sub-system 101 signing an electronic agreement with the seller client 105. In the procedure or network agreement signing method 200 shown in FIG. 2, the signing of the electronic agreement can be started by the transaction platform sub-system/transaction platform server 101 or the seller client 105 in step S201. When the seller wants to newly set up a store in the network transaction platform, the seller client can generate a store setting up request according to an input from the seller and send a request instruction to the transaction platform sub-system to start the signing of the electronic agreement. The transaction platform sub-system can also actively detect whether the desired electronic agreement has been signed between the transaction platform sub-system and the already established store, and in the case where the electronic agreement has not been signed, the transaction platform sub-system generates an agreement signing instruction, so as to start the signing of the electronic agreement for the store.

It can be understood that, in other embodiments, for a store which has already been set up in the network transaction system, it is also possible for the seller client to start the signing of the electronic agreement. In one embodiment, the seller client can generate an agreement signing request according to an input of the seller and send same to the transaction platform sub-system, so as to start the signing of the electronic agreement, and this is similar to starting agreement signing for a newly set up store; therefore, in the present invention, the agreement signing request can be processed in a basically same way as that for a store setting up request.

In one embodiment, the transaction platform sub-system can monitor an order initiated by a buyer thereon, and detect whether the desired electronic agreement has been signed between the transaction platform sub-system and the store corresponding to the order in response to the monitored order. In this way, the detection of the electronic agreement for a certain store is triggered by an order related to the store. In other words, whether the electronic agreement has been signed with the store is only detected in the case where the store may have a transaction with a buyer. As such, for some existing stores on the network transaction platform, although the electronic agreement is not signed, the signing of the electronic agreement can be not started as long as no transaction has occurred. As such, on one hand, the time points of the transaction platform sub-system signing an agreement with a large amount of stores are distributed, avoiding the transaction platform server processing large amounts of data work related to agreement signing in a short time period, reducing the instantaneous load of the transaction platform server; and on the other hand, for those stores which have no transaction later any more, the signing of the electronic agreement will not be started, thus useless data processing is avoided, reducing the total data processing amount of the server.

Monitoring an order by the transaction platform sub-system can be conducted after the order has been submitted by the buyer but before the order has been sent to the seller. After monitoring the order, the transaction platform sub-system can suspend the processing procedure for the order and detect the electronic agreement. In the case where the transaction platform sub-system has detected that the store corresponding to the order has not signed the electronic agreement, the transaction platform sub-system can suspend the subsequent procedure of the order and generate the agreement signing instruction, so as to start the signing of the electronic agreement for the store corresponding to the order. In the case where the transaction platform sub-system has detected that the electronic agreement has been signed with the store corresponding to the order, the subsequent procedure of the order can be continued, for example, sending the order to the seller, so that the transaction between the buyer and the seller normally proceeds.

In one embodiment, the transaction platform sub-system can store corresponding agreement signing state information for the various established stores, for indicating whether the transaction platform sub-system has signed the desired electronic agreement with the store. The agreement signing state information can selectively have a signed state and an unsigned state. It will be seen below that when the signing of the electronic agreement has been completed between the transaction platform sub-system and the store, the agreement signing state information corresponding to the store can be set to the signed state. In this way, the transaction platform sub-system can detect, judge or determine whether the electronic agreement has been signed according to the agreement signing state information about the store. Typically, store information about various stores on the transaction platform sub-system would be stored in the transaction platform sub-system, and the agreement signing state information can be stored in the transaction platform sub-system as a part of the store information.

In step S203, the transaction platform sub-system can acquire the store information about the stores. The required store information can comprise, for example, the seller's name, the seller's address, the seller's registered capital, the seller's receipt account, categories of sold products, other required certificates, etc. This step can be carried out in the case where the transaction platform sub-system does not have the store information about the store or in the case where the existing store information is incomplete. For example, for a store to be set up by the seller, the transaction platform sub-system may have not stored any store information about same. In some other circumstances, a part of the store information about the store is stored in the transaction platform sub-system, but is incomplete for realizing various steps that will be described later. Of course, in the case where the transaction platform sub-system has stored complete store information, especially for a set up store, the store information acquisition step can be omitted.

When the transaction platform sub-system acquires the store information, the store information can be collected by utilizing an information collection form. The information collection form for collecting store information can be configured in advance by the transaction platform sub-system according to the store information required thereby, and the completeness of the store information can be ensured in this way. In one embodiment, in the case where the seller client starts agreement signing, the transaction platform sub-system can return the information collection form to be filled in and a form filling in request to the seller client in response to the store setting up request from the seller client; and in the case where the transaction platform sub-system starts the agreement signing, the transaction platform sub-system can send the information collection form to be filled in and a form filling in request to the seller client in response to an agreement signing instruction generated by the transaction platform sub-system. In another embodiment, the information collection form which has not been filled in can be pre-set in the seller client. In this way, when the transaction platform sub-system acquires the store information, it can send only the form filling in request to the seller client. The seller client can present the information collection form, which is from the transaction platform sub-system or is pre-set, to the seller for same to fill in, in response to the received form filling in request. After the seller has filled the store information in the information collection form by means of the seller client, the seller client sends the information collection form having filled with the store information to the transaction platform sub-system. The transaction platform sub-system extracts the store information from the information collection form, and stores the extracted store information in the transaction platform sub-system. In the case where the information collection form is pre-set in the seller client, for convenience and improving the efficiency, the seller can send the information collection form together with the store setting up request to the transaction platform sub-system after filling in the store information.

In step S205, the transaction platform sub-system can examine the store information about the seller. In one embodiment, the examination can comprise detecting whether the store information is complete for signing the electronic agreement. In the case where the store information is incomplete, the step S203 previously described can be executed to acquire the store information. For example, in the case where the store information is incomplete, the transaction platform sub-system can send a form filling in request to the seller client, so as to collect the store information through the information collection form.

In step S205, examining the store information can further comprise: according to the store information, determining whether the store satisfies an agreement signing requirement for signing the electronic agreement pre-determined by the transaction platform sub-system. In one embodiment, the agreement signing requirement comprises risk assessment for the store. One or more items in the store information acquired by the transaction platform sub-system can be risk relevant items related to store operation risks. As such, the transaction platform sub-system can calculate a risk factor corresponding to the store by utilizing the risk relevant items according to a pre-determined algorithm, and compare the risk factor to a pre-determined risk threshold, and generate a comparison result. In this way, the transaction platform sub-system can determine whether the store satisfies the agreement signing requirement according to the comparison result. To calculate the risk factor, a pre-set risk coefficient and weight corresponding to various risk relevant items can be stored in the transaction platform sub-system. In this way, the corresponding risk factor can be obtained by calculating according to the risk coefficient and weight corresponding to the risk relevant items in the store information. Here, the risk relevant items are used for evaluating the operation risk of a store, and can, for example, comprise: the registered capital of the store, the operation time, the category of sold products, historical buyer comments, the claim history and amount, etc. In such a manner, the store can be examined automatically, so as to reduce manual workload. Of course, auxiliary manual examination can be added based on the automatic examination. Especially, with respect to the claim history and amount, they can be provided by the service fee sub-system to the transaction platform sub-system.

When it is determined that the store does not satisfy the agreement signing requirement according to, for example, the risk factor or other factors, the signing of the electronic agreement can be terminated. In the case where the store does not satisfy the agreement signing requirement, and the signing of the electronic agreement is started by the seller client, for example, through a store setting up request, the transaction platform sub-system can generate and send a piece of request refusal information to the seller client, so as to indicate to the seller that the currently conducted signing of the electronic agreement is terminated and it is refused to set up a store by the seller. In the case where the store does not satisfy the agreement signing requirement, and the signing of the electronic agreement is started by the transaction platform sub-system, for example, through an agreement signing instruction, since the order submitted by the buyer to the store is suspended right now, the transaction platform sub-system can generate and send transaction failure information to the seller client, so as to indicate to the seller that the order is terminated due to that the electronic agreement cannot be signed.

In step S205, examining the store information can further comprise: according to the store information, determining whether the store satisfies an elimination standard pre-determined by the transaction platform sub-system. Such examination is usually later tracking examination of the store which has signed the electronic agreement. For example, when a store reaches an elimination standard of the network transaction platform due to honesty problem in the case of higher claim amount and more bad historical records; at this time, a revocation procedure for revoking the store from the transaction platform sub-system can be started. In one embodiment, the transaction platform sub-system will send an instruction, indicating to terminate the present cooperative relationship, to the seller client according to the signed electronic agreement, and publishes information about the eliminated seller on the network transaction platform, achieving the purpose of forbidding and putting an end to counterfeit and shoddy products on the platform, and informing the consumers of the seller information about the counterfeit and shoddy products.

In the case where the store information examination is passed, the transaction platform sub-system can determine a ratio of the transaction platform sub-system extracting service fee from the store according to a pre-determined policy in step S207. In one embodiment, the policy of determining the service fee ratio can be setting the service fee ratio as a fixed ratio pre-set by the transaction platform sub-system. By way of example, the fixed ratio can be selected between 1% to 5%, and more specifically, the fixed ratio can be 3%. In another embodiment, the service fee ratio can be obtained by calculating according to a pre-determined algorithm based on one or more service fee relevant items in the store information related to the calculation of the service fee ratio. In this case, the transaction platform sub-system can store a pre-set service fee coefficient and weight corresponding to various service fee relevant items, and the service fee ratio is obtained by calculating according to the service fee coefficient and weight corresponding to the service fee relevant items in the store information. Here, the service fee relevant items are used for determining the service fee ratio of the transaction platform sub-system charging a store for each transaction, and can, for example, comprise: registered capital of the store, the category of sold products, the risk factor previously obtained by calculation, etc. In such a manner, the service fee ratio can be calculated automatically, so as to reduce manual workload. Of course, auxiliary manual examination can be added based on the automatic calculation.

After the service fee ratio is determined, the transaction platform sub-system can send the electronic agreement to be signed to the seller client in step S209. In one embodiment, the transaction platform sub-system can generate the required electronic agreement by loading the service fee ratio and other information, such as the seller's name, the seller's address, etc., on a pre-set agreement template. The pre-set agreement template can comprise corresponding clauses for appointing the transaction platform sub-system collecting service fee from the store, and can also comprise clauses about the incentive fund sub-system paying incentive fund to the store and calculation rules for the incentive fund, and so on.

In step S211, the seller client can send to the transaction platform sub-system a confirmation result indicating whether the seller accepts the electronic agreement. Here, after reading the electronic agreement from the transaction platform sub-system by means of the seller client, the seller can input at the seller client an instruction indicating whether the seller accepts the electronic agreement, and the seller client returns a confirmation result indicated by the instruction to the transaction platform sub-system. When the seller refuses to accept the electronic agreement, the transaction platform sub-system can execute basically similar steps as that carried out when the store does not satisfy the agreement signing requirement. In particular, in the case where the seller refuses to accept the electronic agreement, and the signing of the electronic agreement is started by the seller client, for example, through a store setting up request, the transaction platform sub-system can generate and send a piece of request refusal information to the seller client in step S213, so as to indicate to the seller that the currently conducted signing of the electronic agreement is terminated and it is refused to set up a store by the seller. In the case where the seller refuses to accept the electronic agreement, and the signing of the electronic agreement is started by the transaction platform sub-system, for example, through an agreement signing instruction, since the order submitted by the buyer to the store is suspended right now, the transaction platform sub-system can generate and send transaction failure information to the seller client in step S213, so as to indicate to the seller that the order is terminated due to that the electronic agreement cannot be signed.

In the case where the transaction platform sub-system receives a confirmation result from the seller client indicating that the seller accepts the electronic agreement, the transaction platform sub-system can send information about agreement signing success to the seller client. When the store is a newly set up store, the transaction platform sub-system can also send to the seller client information about store setting up success and information such as store registration number, store network address, etc., corresponding to the store, so as to indicate that the network transaction platform has formed a cooperative relationship with the seller, and that the seller can present and sell related products on the platform.

As previously described, whether the transaction platform sub-system has signed the electronic agreement with the store can be indicated with agreement signing state information. In this way, after step S211 or S213, the transaction platform sub-system can set the agreement signing state information about the corresponding store to a signed state.

Additionally, an agreement signing state flag visible to the buyer corresponding to the agreement signing state information can be generated in a page of the store presented by the transaction platform sub-system to the buyer. As such, the buyer on the transaction platform sub-system identifies, by means of the agreement signing state flag on the page of the store, whether the store is a store having signed the electronic agreement with the platform.

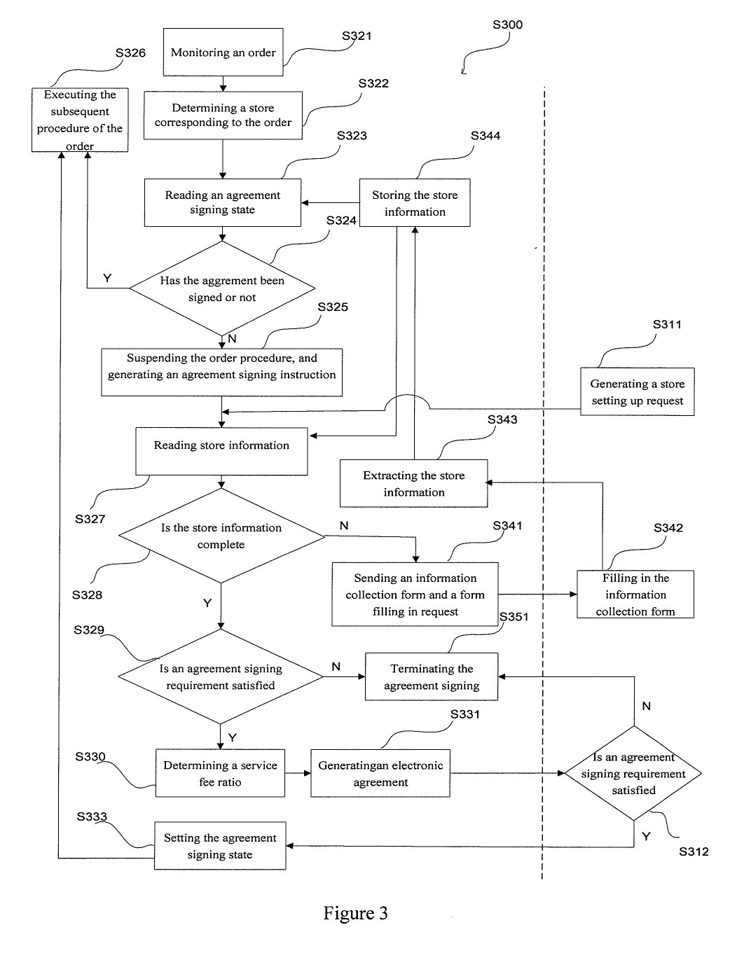

The implementation procedure of the network transaction system or the network agreement signing method 300 shown in FIG. 3 is a more particular implementation of the procedure 200 in FIG. 2. In FIG. 3, a vertical dotted line is drawn, the left side of the dotted line indicates the actions and procedure executed by the transaction platform sub-system of the transaction platform server, and the right side of the dotted line indicates the actions and procedure executed by the seller client at the seller's side.

As shown in FIG. 3, the procedure 300 can be initiated by step S311 executed at the seller client or by steps S321 to S325 executed at the transaction platform sub-system. In step S311, when the seller wants to newly set up a store in the transaction platform sub-system, the seller client can generate a store setting up request according to an input from the seller and send same to the transaction platform sub-system to start the signing of the electronic agreement. In steps S321 to S325, the transaction platform sub-system can actively detect whether the desired electronic agreement has been signed between the transaction platform sub-system and the already established store, and in the case where the electronic agreement has not been signed, the transaction platform sub-system generates an agreement signing instruction, so as to start the signing the of electronic agreement for the store. In particular, in step S321, the transaction platform sub-system can monitor an order initiated by a buyer thereon. As previously described, monitoring an order by the transaction platform sub-system can be conducted after the order has been submitted by the buyer but before the order has been sent to the seller. In step S322, in response to the monitored order, a store corresponding to the order is determined according to information about the order. In step S323, agreement signing state information is read from the store information corresponding to the order stored in step S344. In step S324, whether the store has signed the required electronic agreement with the transaction platform sub-system is judged according to the agreement signing state information. When the electronic agreement has not been signed, step S325 is carried out, and the transaction platform sub-system can discontinue or suspend the subsequent procedure of the order and generate the agreement signing instruction, so as to start the signing of the electronic agreement for the store corresponding to the order. In the case where the transaction platform sub-system has detected that the electronic agreement has been signed with the store corresponding to the order, the subsequent procedure of the order can be continued in step S326, for example, sending the order to the seller, so that the transaction between the buyer and the seller normally proceeds.

In step S327, the store information about the store can be read, so as to conduct a subsequent examination procedure. During the examination of the store, whether the store information is complete for signing the electronic agreement can be detected in step S328. In the case where the store information is incomplete, the store information acquisition process in steps S341 to S344 can be executed. In the case where the store information is complete, whether the store satisfies an agreement signing requirement for signing the electronic agreement pre-determined by the transaction platform sub-system can be determined according to the store information in S329. In the case where the store does not satisfy the agreement signing requirement, an agreement signing termination procedure in step S351 can be executed.

As previously described, the judgement about whether the agreement signing requirement is satisfied in step S329 can also be used for determining, for a signed store, whether the store satisfies an elimination standard pre-determined by the transaction platform sub-system.

In the case where the store satisfies the agreement signing requirement, step S330 can be executed, where the transaction platform sub-system determines a ratio of the transaction platform sub-system collecting service fee from the store according to a pre-determined policy. After the service fee ratio is determined, the transaction platform sub-system can generate the required electronic agreement by loading the service fee ratio on a pre-set agreement template and send same to the seller client in step S331. The pre-set agreement template can comprise relevant clauses for appointing the transaction platform sub-system collecting service fee from the store.

After the seller client receives the electronic agreement from the transaction platform sub-system, the seller can input at the seller client an instruction indicating whether the seller accepts the electronic agreement, and the seller client returns a confirmation result indicated by the instruction to the transaction platform sub-system, in step S312. When the seller refuses to accept the electronic agreement, the agreement signing termination procedure in step S351 can be executed. When the seller accepts the electronic agreement, step S333 can be executed. In step S333, the agreement signing state information in the store information about the store can be set to a signed state.

In the store information acquisition procedure in steps S341 to S344, the store information can be collected by utilizing an information collection form. In step S341, the transaction platform sub-system sends the information collection form to be filled in and a form filling in request to the seller client. In step S342, the seller client can present the information collection form, which is from the transaction platform sub-system, to the seller for same to fill in, in response to the received form filling in request, and the seller client sends the information collection form having filled with the store information to the transaction platform sub-system. In step S343, The transaction platform sub-system extracts the store information from the information collection form, and stores the extracted store information in the transaction platform sub-system in step S344.

In other embodiments, the store information can also be acquired in a manner different from that in steps S341 to S344. In one embodiment, the information collection form which has not been filled in can be pre-set in the seller client. In this way, when the transaction platform sub-system acquires the store information, it can send only the form filling in request to the seller client. In another embodiment, in the case where the information collection form is pre-set in the seller client, for convenience and improving the efficiency, steps S311 and S342 can be executed basically simultaneously at the seller client, so that the seller client sends the filled information collection form together with the store setting up request to the transaction platform sub-system. In yet another embodiment, before step S328, the transaction platform sub-system can send the information collection form to be filled in and the form filling in request to the seller client in response to the store setting up request from the seller client or an agreement signing instruction generated in the transaction platform sub-system.

With respect to the agreement signing termination procedure in step S351, different procedures are adopted depending on the starting of the agreement signing. In particular, in the case where the signing of the electronic agreement is started by the seller client, for example, through a store setting up request, the transaction platform sub-system can generate and send a piece of request refusal information to the seller client, so as to indicate to the seller that the currently conducted signing of the electronic agreement is terminated and it is refused to set up a store by the seller. In the case where the signing of the electronic agreement is started by the transaction platform sub-system, for example, through an agreement signing instruction, since the order submitted by the buyer to the store is suspended right now, the transaction platform sub-system can generate and send transaction failure information to the seller client, so as to indicate to the seller that the order is terminated due to that the electronic agreement cannot be signed.

With regard to portions not described in this embodiment, such as the content of the store information, the particular examination manner in step S329, the particular determination mode for the service fee ratio in step S330, reference can be made to corresponding description of the procedure 200 shown in FIG. 2.

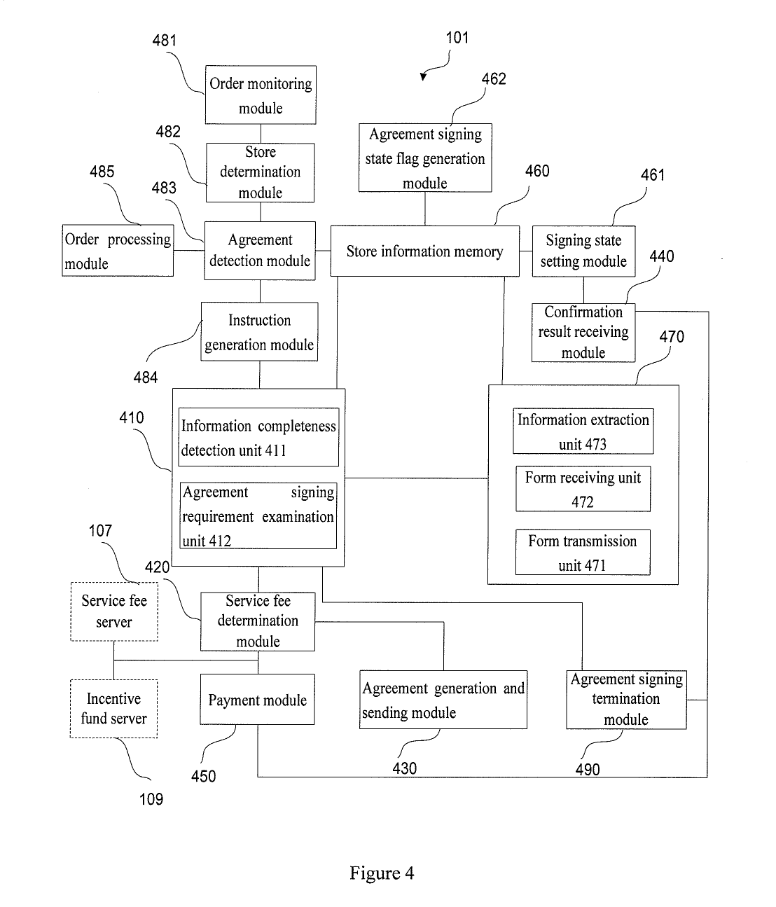

FIG. 4 is a structural schematic diagram of the transaction platform server or transaction platform sub-system 101 for executing the previously described network agreement signing method 200 or 300, which is used for interacting with the seller client 105 through the network 103, so that the seller completes a transaction with a buyer on the transaction platform sub-system, and completes the capital flow with an electronic account in the network transaction system at the same time. As shown in FIG. 4, the transaction platform server 400 can comprise a store examination module 410, a service fee determination module 420, an agreement generation and sending module 430, a confirmation result receiving module 440 and a payment module 450. An agreement signing procedure executed by the transaction platform server 101 can be started in response to an agreement signing instruction generated by an instruction generation module 484 therein or a store setting up request from the seller client.

The store examination module 410 can be configured to read store information about a store to be examined from a store information memory 460, and make examination based on the store information, to generate an examination result. The store information examination module 410 can comprise an information completeness detection unit 411 and an agreement signing requirement examination unit 412. The information completeness detection unit 411 can be configured to detect whether the store information is complete for signing the electronic agreement. Moreover, in the case where the store information is incomplete, the information completeness detection unit 411 can send an information acquisition request to a store information acquisition module 470. The store information acquisition module 470 can send a form filling in request and an optional information collection form to the seller client in response to the information acquisition request. The agreement signing requirement examination unit 412 can determine according to the store information whether the store satisfies a pre-determined requirement for signing the electronic agreement. In one embodiment, one or more items in the store information are risk relevant items related to store operation risks. The agreement signing requirement examination unit 412 can calculate a risk factor of the store by utilizing the risk relevant items according to a pre-determined algorithm, compare the risk factor to a pre-determined risk threshold, and determine whether the current store satisfies the agreement signing requirement according to a comparison result. The transaction platform server 101 can pre-store a pre-set risk coefficient and weight corresponding to various risk relevant items, and the risk factor can be obtained by calculating according to the risk coefficient and weight of the risk relevant items in the store information.

The service fee determination module 420 can determine a ratio of the transaction platform sub-system extracting service fee from the store according to a pre-determined policy, in response to an examination result from the store examination module 410 indicating that the examination is passed. In one embodiment, the service fee determination module 420 can set the service fee ratio as a pre-set fixed ratio. In another embodiment, one or more items in the store information are service fee relevant items related to the calculation of the service fee ratio. The service fee determination module 420 can calculate the service fee ratio by utilizing the service fee relevant items according to a pre-determined algorithm. The transaction platform server 101 can pre-store a pre-set service fee coefficient and weight corresponding to various service fee relevant items, and the service fee ratio can be obtained by calculating according to the service fee coefficient and weight of the service fee relevant items in the store information.

The agreement generation and sending module 430 can load on a pre-set agreement template the service fee ratio determined by the service fee determination module 420 to generate an electronic agreement to be signed, and send the electronic agreement to the seller client. The generated electronic agreement can comprise a convention about a service fee ratio of the transaction platform sub-system collecting service fee from a store.

The confirmation result receiving module 440 can receive a confirmation result from the seller client indicating whether the seller accepts the electronic agreement. Store information stored in the store information memory 460 can comprise registered capital information and receipt account information about a store.

The transaction platform server can also comprise a signing state setting module 461. The store information stored in the store information memory 460 can comprise the agreement signing state information, for indicating whether the transaction platform sub-system has signed the required electronic agreement with the store, and the agreement signing state information selectively has a signed state and an unsigned state. The signing state setting module 461 can set the agreement signing state information corresponding to the store in the store information memory 460 to be a signed state, in response to a confirmation result received by the confirmation result receiving module 440 indicating that the seller accepts the electronic agreement. An agreement signing state flag generation module 462 can generate, in a page of the store presented to the buyer by the transaction platform sub-system, an agreement signing state flag visible to the buyer corresponding to the agreement signing state information, for presenting to the buyer whether the store has signed the required electronic agreement with the transaction platform sub-system.

Cooperating with the instruction generation module 484, the transaction platform server 101 can also comprise an order monitoring module 481, a store determination module 482 and an agreement detection module 483, so that the transaction platform server 101 actively produces an agreement signing procedure.

The order monitoring module 481 can monitor an order initiated by a buyer on the transaction platform sub-system. In response to the order monitored by the order monitoring module 481, the store determination module 482 determines a store corresponding to the order. For the store determined by the store determination module 482, the agreement detection module 483 can read agreement signing state information corresponding to the store from the store information memory 460, and determine whether the store has signed the required electronic agreement with the transaction platform sub-system according to the agreement signing state information. In the case where the agreement detection module 483 determines that the current store has not signed the electronic agreement, the instruction generation module 484 can generate an agreement signing instruction, so as to initiate an agreement signing procedure for the store. At the same time, an order processing module 485 for managing an order procedure can suspend the procedure of a current order. In the case where the agreement detection module 483 determines that the current store has signed the electronic agreement, the order processing module 485 can continue processing the subsequent procedure of the current order.

The store information acquisition module 470 is used for acquiring store information about a store. The store information acquisition module 470 can comprise a form transmission unit 471, a form receiving unit 472 and an information extraction unit 473. The form transmission unit 471 can send an information collection form to be filled in and a form filling in request to the seller client in response to an information acquisition request sent by the information completeness detection unit 411 when the information is incomplete. At the seller client, the seller client can present the information collection form to the seller for same to fill in, in response to the form filling in request. In another embodiment, the form transmission unit 471 can send the information collection form to be filled in and a form filling in request to the seller client in response to the agreement signing instruction generated by the instruction generation module 484 or the store setting up request from the seller client. In yet another embodiment, when an information collection form is pre-set on the seller client, the form transmission unit 471 can merely send a form filling in request. The form receiving unit 472 can receive an information collection form from the seller client in which the store information has been filled. The information extraction unit 473 can extract the store information from the information collection form received by the form receiving unit 472, and store the store information in a store information memory 460.

When the confirmation result receiving module 440 receives a confirmation result indicating that the seller refuses to accept the electronic agreement, or when the agreement signing requirement examination unit 412 has determined that the store does not satisfy the agreement signing requirement, an agreement signing termination module 490 can execute an agreement signing termination procedure. In the case where the signing of the electronic agreement is started by the seller client, the agreement signing termination module 490 generates and sends a piece of request refusal information to the seller client, so as to indicate to the seller that the currently conducted signing of the electronic agreement is terminated. In the case where the signing of the electronic agreement is started by the transaction platform sub-system, the agreement signing termination module 490 generates and sends transaction failure information to the seller client, so as to indicate to the seller that the current order is terminated due to that the electronic agreement cannot be signed.

In the case where the seller has signed the previously described electronic agreement with the network transaction system, a buyer can view products of the seller on the platform, and when having decided to buy a product, the buyer places an order and pays for it through a buyer client. The transaction platform server 101 freezes the transactional capital, i.e. payment, through the payment module 450, and unfreezes the transactional capital after the seller has delivered the product and the buyer has confirmed the delivery. The payment module 450 calculates service fee according to the transactional capital and the service fee ratio determined by the service fee determination module 420, and extracts the service fee from the transactional capital and sends or transfers same to the service fee server 107, and sends data corresponding to the service fee to the incentive fund server 109 and the service fee server 107. At the same time, the payment module 450 transfers net transactional capital, remained after deducting the service fee from the transactional capital, to the seller, and sends the net transactional capital data and the service fee data to the seller client. The incentive fund server 109 processes the ratio occupied by the service fee paid by various sellers or stores in the total service fee, and pays corresponding incentive fund to the various sellers, wherein the total amount of the incentive fund is related to the material profit and financial profit of the network transaction platform.

Various embodiments regarding components in the present invention may be implemented in hardware, or implemented by software modules running on one or more processors, or implemented in combinations thereof. It should be understood, for those skilled in the art, that a microprocessor or a digital signal processor (DSP) may be used in practice to implement some or all of the functions of some or all of the components in the apparatus according to the embodiments of the present invention. The present invention can further be implemented as devices or apparatus programs (e.g., computer programs and computer program products) for executing some or all of the methods as described herein. Such programs for implementing the present invention may be stored on a computer-readable medium, or may be in the form of one or more signals. Such signals can be obtained by downloading from an Internet website, or provided on a carrier signal, or provided in any other form.

Up to this, a person skilled in the art should recognize that although a plurality of exemplary embodiments of the present invention have been shown and described in detail herein, numerous other variations or modifications meeting the principle of the present invention can be directly determined or derived according to the contents disclosed in the present invention, without departing from the spirit and scope of the present invention. Therefore, the scope of the present invention should be construed and considered as covering all of such other variations or modifications.

1. A network transaction system for a network transaction platform, comprising a transaction platform sub-system, a service fee sub-system, an incentive fund sub-system and a seller client, which are mutually independent or relatively independent, wherein:
the transaction platform sub-system is configured to provide a network transaction platform between a buyer and a seller and manage the transaction procedure and transactional capital of each transaction between the buyer and the seller; and the transaction platform sub-system is further configured to calculate service fee data for transactional capital of each transaction according to a pre-determined service fee ratio, to send each of the service fee data to the service fee sub-system and the incentive fund sub-system, and to send service fee corresponding to each of the service fee data to the service fee sub-system;
the service fee sub-system is configured to receive each of the service fee data and the corresponding service fee from the transaction platform sub-system; and
the incentive fund sub-system is configured to receive each of the service fee data from the transaction platform sub-system, and calculate, according to all service fee data in a pre-determined period, a seller payment ratio of the sum of service fee corresponding to all transactions of each seller in the pre-determined period to a total service fee in the pre-determined period; and the incentive fund sub-system is further configured to send corresponding incentive fund to a corresponding seller based on the seller payment ratio of each seller according to the total incentive fund in the pre-determined period.

2. (canceled)

3. The network transaction system according to claim 1, wherein the transaction platform sub-system is further configured to receive a right defending request from the buyer and forward the right defending request to the service fee sub-system; and,
the service fee sub-system is further configured to send compensation fund to the buyer in the case where the right defending request of the buyer is established.

4. (canceled)

5. The network transaction system according to claim 1, wherein the transaction platform sub-system and the seller client are further configured to interact via a network, so as to sign an electronic agreement between the transaction platform sub-system and the seller; and
the electronic agreement comprises a convention related to the service fee and the incentive fund.

6.-12. (canceled)

13. The network transaction system according to claim 1, wherein the transaction platform sub-system is further configured to acquire store information about the store.

14.-18. (canceled)

19. The network transaction system according to claim 1, wherein the transaction platform sub-system is further configured to examine store information about a store of the seller.

20.-25. (canceled)

26. The network transaction system according to claim 1, wherein the service fee ratio is a pre-set fixed ratio, and wherein the fixed ratio is selected from one of the ranges and value of 0-8%, 1%-5%, and 3%.

27. The network transaction system according to claim 1, wherein the service fee ratio is a ratio related to a store calculated according to store information, and one or more items in the store information are service fee relevant items related to the service fee ratio calculation; and
wherein the transaction platform sub-system is further configured to calculate the service fee ratio by utilizing the service fee relevant items according to a pre-determined algorithm.

28. (canceled)

29. The network transaction system according to claim 1, wherein the service fee ratio is inversely proportional to an accumulated transaction volume of the store, thus the service fee ratio gradually decreases as the transaction volume of the store increases; and wherein the starting point of the service fee ratio is 8%.

30. The network transaction system according to claim 1, wherein the transaction platform sub-system is further configured to load the service fee ratio on a pre-set agreement template, so as to generate the electronic agreement.

31. The network transaction system according to claim 1, wherein the transaction platform sub-system is further configured to terminate signing the electronic agreement in the case of receiving a confirmation result from the seller client indicating that the seller refuses to accept the electronic agreement.

32. (canceled)

33. A transaction platform server for a network transaction system, for interacting with a service fee server, an incentive fund server and a seller client through a network, so as to manage the transaction procedure and transactional capital of each transaction on a network transaction platform between a buyer and a seller and complete a capital flow between electronic accounts of the buyer and the seller, the transaction platform server comprising:
a store examination module configured to examine store information about the seller's store;
a service fee determination module configured to determine according to a pre-determined policy a service fee ratio that the transaction platform server would charge the store;
an agreement generation and sending module configured to load the service fee ratio on a pre-set agreement template to generate an electronic agreement to be signed, and send the electronic agreement to the seller client, wherein the electronic agreement comprises a convention related to the service fee;
a confirmation result receiving module configured to receive a confirmation result from the seller client indicating whether the seller accepts the electronic agreement; and
a payment module configured to pay the service fee corresponding to the service fee data to an electronic account corresponding to the service fee server, and pay net transactional capital to an electronic account corresponding to the seller client after deducting the service fee from the transaction capital;
wherein the transaction platform server starts the signing of the electronic agreement in response to an agreement signing instruction in the transaction platform server or a store setting up request from the seller client.

34.-38. (canceled)

39. The transaction platform server according to claim 33, further comprising:
a store information acquisition module configured to acquire the store information about the store.

40.-41. (canceled)

42. The transaction platform server according to claim 33, wherein the store examination module comprises:
an information completeness detection unit configured to detect whether the store information is complete for signing the electronic agreement.

43. (canceled)

44. The transaction platform server according to claim 33, wherein the store information examination module comprises:
an agreement signing requirement examination unit configured to determine according to the store information whether the store satisfies a pre-determined requirement for signing the electronic agreement.

45.-50. (canceled)

51. The transaction platform server according to claim 33, further comprising:
a right defending request receiving and forwarding module configured to receive a right defending request from the buyer and forward the right defending request to the service fee server.

52. (canceled)

53. A network agreement signing method, for interaction between a network transaction platform and a seller client at a seller side via a network, configured to sign an electronic agreement between the network transaction platform and a seller of a store on the network transaction platform, the method comprising:
starting the signing of the electronic agreement;
examining store information about the seller's store;
sending the electronic agreement to be signed to the seller client; and
sending, to the network transaction platform, a confirmation result indicating whether the seller accepts the electronic agreement.

54.-59. (canceled)

60. The method according to claim 53, further comprising: acquiring the store information about the store.

61.-65. (canceled)

66. The method according to claim 53, wherein examining the store information comprises: detecting whether the store information is complete for signing the electronic agreement.

67. (canceled)

68. The method according to claim 53, wherein examining the store information comprises:
determining, according to the store information, whether the store satisfies an agreement signing requirement for signing the electronic agreement pre-determined by the network transaction platform; and
when the store does not satisfy the agreement signing requirement, terminating signing the electronic agreement.

69.-70. (canceled)

71. The method according to claim 53, wherein the network transaction platform terminates signing the electronic agreement in case of receiving a confirmation result from the seller client indicating that the seller refuses to accept the electronic agreement.

72.-73. (canceled)
